(19) United States
(12) Patent Application Publication
(10) Pub. No.: US 2025/0377986 A1
(43) Pub. Date: Dec. 11, 2025

(54) AUTOMATED DRIFT DETECTION AND RECONCILIATION

(71) Applicant: HEWLETT PACKARD ENTERPRISE DEVELOPMENT LP, Spring, TX (US)

(72) Inventors: Madhumita Bharde, Andover, MA (US); Agam Jain, Bangalore (IN); Devendra Kumar, Bangalore (IN)

(21) Appl. No.: 18/978,873

(22) Filed: Dec. 12, 2024

(30) Foreign Application Priority Data
Jun. 7, 2024 (IN) 202441044188

(51) Int. Cl. G06F 11/14; G06F 16/25

(52) U.S. Cl. CPC G06F 11/1469; G06F 16/254; G06F 2201/80

(57) ABSTRACT

Systems and methods are provided for data drift detection and reconciliation by establishing ground truth through the determination of any changes in the source data via restored current and previous snapshots of an operational/transactional database. Changes in lakehouse data can be identified via the use of raw data events from which reconstructed tables are determined, and changes in business intelligence tables can be identified based on the application of data mapping rules to the raw data events, such that these changes can be compared to determine if data drift has occurred.

### CROSS REFERENCE TO RELATED APPLICATIONS

This application claims the benefit of and priority to IN Provisional Patent Application No. 202441044188, filed on Jun. 7, 2024, the contents of which are incorporated herein by reference in their entirety.

### BACKGROUND

Operational (also referred to as transactional) systems can refer to systems that are used to maintain records of business transactions in an organization. Business transactions can encompass a variety of transactions, e.g., payroll, inventory, ordering, etc. Operational systems typically use some form of relational database management system to manage their data. Such relational database management systems are geared towards transactional workloads, e.g., relatively low-volume (touching fewer rows of a database table) read/write operations with known transaction patterns. Data warehouses, another type of database management system, are geared towards high-volume scanning of data related to analytics that can provide insights into a business. For example, a data scientist may wish to understand trends in customer subscription behavior, with a focus on ad hoc queries to gain insight into structured data. An enterprise may leverage both operational databases to conduct typical transactions (adding/removing a customer) and data warehouses to conduct analytics (the aforementioned subscription trend analysis). In more recent times, another type of data management system referred to as a data lake has come into prominence. In contrast to data warehouses, data lakes tend to be more supportive of artificial intelligence (AI)-oriented insight (versus the business intelligence (BI) typically supported by the data warehouses), with data storage being more unstructured/semi-structured.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a high-level schematic representation of a drift and reconciliation system architecture in accordance with examples of the disclosed technology.

FIG. 2 illustrates example components and functionality of a lakehouse leveraged by examples of the disclosed technology.

FIG. 3A is a detailed schematic representation of the operational and lakehouse aspects of the drift and reconciliation system architecture of FIG. 2A.

FIG. 3B is a detailed schematic representation of the lakehouse and drift and reconciliation operational aspects of the drift and reconciliation system architecture of FIG. 2A.

FIG. 4 is an example computing component that may execute instructions to perform data drift detection in accordance with examples of the disclosed technology.

FIG. 5 is an example computing component that may execute instructions to perform data drift detection and reconciliation in accordance with examples of the disclosed technology.

FIG. 6 is an example computing component that may be used to implement various features of examples of the disclosed technology.

The figures are not exhaustive and do not limit the present disclosure to the precise form disclosed.

### DETAILED DESCRIPTION

For various reasons, including but not limited to data loss, duplication, retries, errors, etc., data stored in a data warehouse may “drift” from that stored in the source transactional database, also known as ground truth. In other words, the data stored in the data warehouse no longer matches or comports with the data stored in the source transactional database. For example, some action or event on the data stored in the source transactional database may not be reflected by the data stored in the data warehouse. As noted above, data warehouses are supposed to be the sole source of truth for decision making and analytics. This can be problematic because business decisions, whether they are operational, strategic, or financial can be negatively impacted by inaccurate data. For example, if a business decides to react or address some subscription trend based on subscription trend analysis performed on a data warehouse copy or version of the data stored in the transactional database, and that analysis was based on inaccurate data representing the subscription trend, the business may react or address the subscription trend incorrectly resulting in unhappy customers or the loss of customers. In other words, it is paramount for businesses to have confidence in data maintained in a data warehouse with respect to data quality dimensions, e.g., accuracy, timeliness, completeness, integrity, uniqueness, and consistency.

Conventional methods for drift detection between transactional and analytical systems are based on drift detection (e.g., row-by-row comparisons) in the context of database migrations. Such conventional methods can consume an inordinate amount of resources (typically involving extra queries or replication in the operational database) thereby possibly overloading or disrupting the operational system, often forcing such actions to be performed during maintenance windows. Conventional drift detection methods can also be costly to perform because of the amount of resources used. Heuristic methods are not always exact, and thus, cannot provide the requisite confidence for data in a data warehouse. Examples of conventional drift detection methods may include classic count checking, numerical column aggregation (e.g., sum, max, min), boundary conditions, functional checks, and sampling.

Data warehouse-based data reconciliation is equally inefficient, oftentimes involving the performance of a full load of data or replaying many past events to understand any data drift (mostly due to the aforementioned, inaccurate drift detection in data warehouses using conventional drift detection methods). Further still, scripts for a domain that are used to perform checks to detect and reconcile data warehouses typically involve customized scripts, not to mention, manual intervention/judgment are often used because of the different ways in which data drift can occur. Thus, conventional reconciliation can be a huge challenge in terms of maintainability, supportability (the human/manual aspect attributing to laboriousness, inordinate time consumption, and increased risk of errors).

Generally, the development of data reconciliation solutions are costly, and are based on the application of significant technical know-how, e.g., most every new data warehouse Extract-Transform-Load (ETL) process is custom, and thus is typically not reusable in other data warehouses or other contexts. Additionally, database migrations (moving data from one database to another) do not result in any changes to the data schema. With no schema changes, the data remains more or less the same. However, when moving data from a transactional database to an analytical database, the data is often transformed or modeled to be more suitable for analytics processing, making the detecting of drift difficult because simple diffs/comparisons are not effective when different schemas are involved, e.g., rows and columns may no longer match across databases due to joins or aggregations. That is, between a source/transactional/operational system and an analytical warehouse, their respective underlying database technologies/data formats typically differ (e.g., Postgres versus Vertica). The same is true of the underlying data models in the analytical database where, as noted above, BI can be implemented (a BI model may comprise sets of BI tables).

In more recent times, another type of data management system referred to as a data lake has come into prominence. In contrast to data warehouses, data lakes tend to be more supportive of artificial intelligence (AI)-oriented insight (versus the business intelligence (BI) typically supported by the data warehouses), with data storage being more unstructured/semi-structured. More recently still, lakehouses have emerged that purport to offer the advantages of traditional data warehouses and data lakes. Some of the advantages of lakehouses come in the form of flexible and cost efficient data storage (cheap cloud storage) in unstructured/semi-structured form (columnar data formats, open table formats, open source querying with MPP capabilities), along with the ability to maintain transaction logs or change data feeds. Unfortunately, existing methods for drift detection and reconciliation that are, as noted above, not ideal for data warehouses (the existing methods being outdated and inefficient), are also non-ideal for lakehouses.

Like the difference in schema between transactional databases and data warehouses, when data is moved from a transactional database to a lakehouse to facilitate desired analytics, that operational or source data is again, typically transformed by way of joins, aggregation, denormalization, etc. Thus the data schemas between transactional databases and lakehouses are also different, adding to the difficulty in detecting and reconciling drift.

Accordingly, examples of the disclosed technology are directed to drift detection and reconciliation systems and methods that are better suited to lakehouses, and avoid the downfalls of traditional data drift detection and reconciliation methods noted above. In this way, the integrity of data stored/used in an analytical database/lakehouse is ensured (i.e., it matches that of the transactional database).

A current snapshot of the transactional database is taken, as well as another snapshot of the transactional database's state in the relevant time period previous to the current snapshot, e.g., the relevant time period may refer to weekly or daily snapshots. In this way, a ground truth for any changes to the source operational data is established, recalling that in order to detect whether or not data in the analytical database has drifted from that of the transactional database, changes to the source operation data should be known. These snapshots are copied into the lakehouse, are staged in the lakehouse, and restored. After restoration, in accordance with examples of the disclosed technology for effective drift and reconciliation methods disclosed herein, changes in the restored source operational data (derived from the snapshots) are determined. That is, copies of the state of the data stored in the transactional database can be generated by the lakehouse, and can serve as a validation mechanism, i.e., a reconstructed ground truth inclusive of any changes to the data that occurred between the current and previous snapshots. It should be noted that in some examples of the disclosed technology, detecting changes in the source, e.g., taking, storing, and comparing snapshots need not necessarily occur in the lakehouse. For example, changes in source can be detected by a system hosted anywhere. If an operational system is using a postgres database, a separate instance of postgres can be configured to use a pg_comparator tool to detect changes.

In parallel, the operational system can perform continuous data capture (CDC) on the transactional database, which it can then “dump” into the lakehouse. This raw (event) data can be merged. Merging in this context refers to reconstructing the tables of the transactional database in accordance with observed events (deletes, writes, etc.) captured or reflected in the raw data. The result is one or more reconstructed tables. The disclosed drift detection methods may then determine any changes in the reconstructed tables. It should be noted that the raw events provided by the operational system would be those that the transactional database snapshots theoretically should represent. In the other words, now, a comparison can be made between detected changes in the reconstructed tables and any detected changes between the restored current and previous source transactional databases. That is, and as noted above, lakehouses have the ability to maintain a data transaction log, and can therefore, provide a change data feed. Thus, changes to the reconstructed tables (as well as BI tables, described in greater detail below, or any other data tables in a lakehouse) are readily available/known. It should be understood that the lakehouse may correctly represent the state of the data in the transactional database, but the events/changes to the data (and may be of interest for purposes of analyzing the data), may not have been captured. Reconstructing the transactional database tables using the raw event data to recreate/reconstruct the data from the perspective of the events leading to changes in the data provides another view of the data that can be compared to the restored ground truth reflected by restored source/previous snapshots and the detected changes therein.

If appropriate, reconciliation measures may be taken. Since the exact drift has been identified between the transactional database and the lakehouse, including any events causing changes to the data that led to the determined drift, corrective events to apply to the lakehouse tables to bring them in line with the transactional database tables are known. The reconciliation methods disclosed herein may compare the changes in source (operational system/transactional database) to the changes in destination (lakehouse) to determine the delta between them to create the events in a desired format, and to apply them to the data pipeline. A metadata field in the event is implemented in order to keep track of corrective events for cataloging purposes. This artificial manufacturing of events to remove the drift and achieve reconciliation, makes it possible to leverage the operational path for the reconciliation process instead of creating a separate reconciliation pipeline. Any such manufactured or generated events can be applied to the raw data stage as opposed to directly correcting final business intelligence views (pursuant to queries on the lakehouse). Although not necessary, this is a preferred approach because it ensures that all stages of processing are in sync, that end-to-end cataloging of changes that occurred exists, and that replay-ability of events is possible, if desired.

To achieve this, the service may need to know data mapping rules and may need to get extra data from the latest restored snapshot to generate all “corrective” events depending on the complexity of data transformation in the lakehouse. When the context of the data is known, corrective events are gleaned directly from the data. However, in other cases, denormalization or aggregation operations may be performed to effectuate the desired data-mapping and transformations to bring raw events data received by lakehouse in line with the data of the transactional database represented by the snapshots.

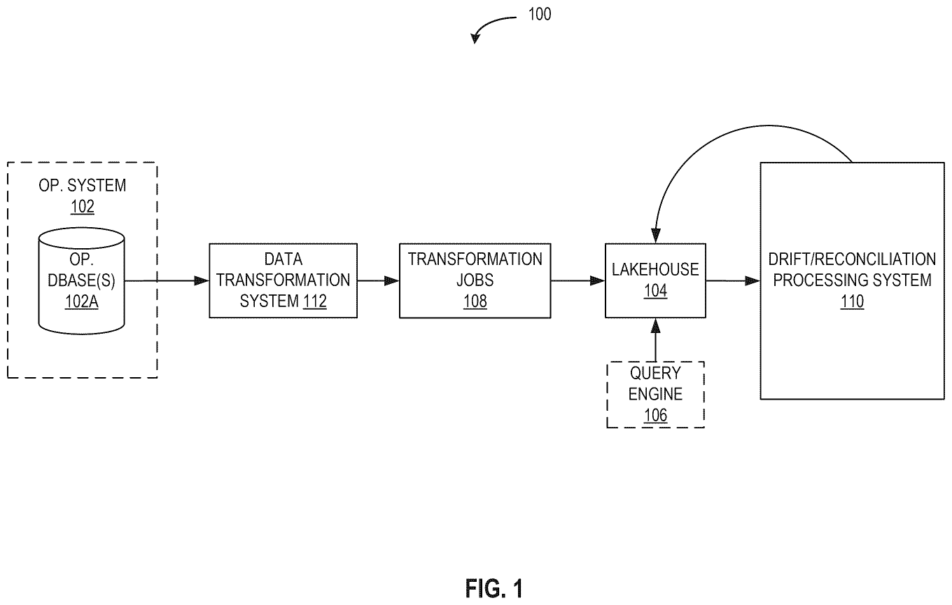

FIG. 1 illustrates an example, high-level schematic representation of a drift detection and reconciliation system 100. System 100 may comprise an operational system 102 (including operational/transactional database(s) 102A), a data transformation system 112, and analytical system (including lakehouse 104, query engine 106, and transformation jobs 108) in which examples of the disclosed technology may be implemented. System 100 may further comprise drift and reconciliation processing system 110, which may interact with lakehouse 104 to determine any drift in the data maintained by operational database 102A and

The one or more operational databases 102A may comprise data repositories configured to store or otherwise maintain data of interest (e.g., health data regarding components of example operational system 100, customer data associated with a subscription service, etc.). As noted above, the one or more operational databases 102A typically will comprise a relational database management system with atomicity, consistency, isolation, and durability (ACID) guarantees for high-performance, low-volume (fewer touching of rows) reads and writes with known transaction patterns. For example, updating customer lists/information may be a transaction performed at the one or more operational databases 102A.

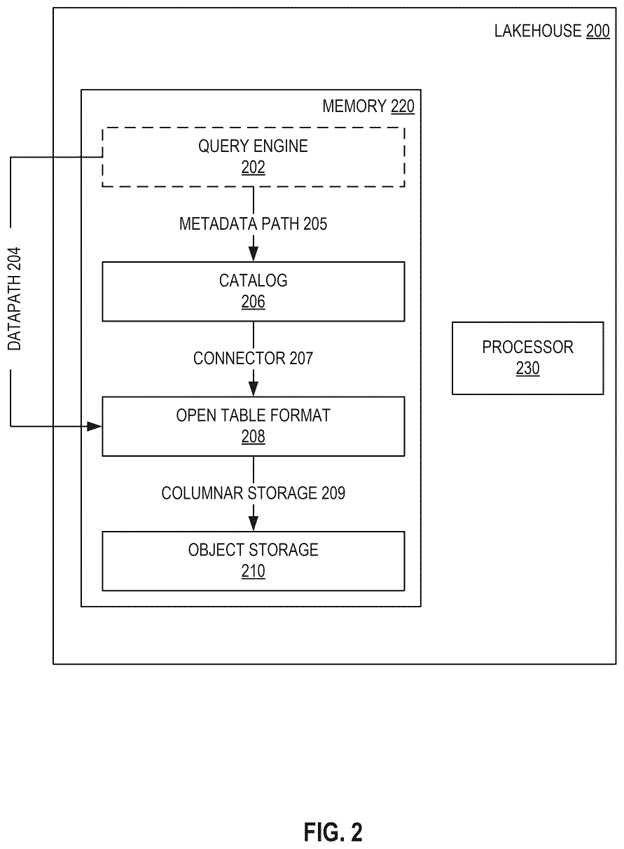

Typically, data stored in the one or more operational databases 102A can be obtained and transformed into a lakehouse, e.g., lakehouse 104. An end-user (not shown), may use query engine 106 to perform queries on the data stored in lakehouse 104. Query engine 106 may, in some examples, be considered a part of lakehouse 104 (see, e.g., FIG. 2), or may be considered to be separate from lakehouse 104 (see, e.g., FIG. 1). Regardless of the location of its implementation, query engine 106 can refer to any software or interface that interacts with a data source or repository, such as lakehouse 104. Such a query engine can execute queries (requests for information) against data, such as data stored in lakehouse 104. One example query engine may be a SQL query engine that can interpret SQL commands and language to access data in a relational database. It should be noted that multiple query engines may access/interact with a particular database, and alternatively, a single query engine may be configured to query data from multiple data sources, e.g., in a single query.

As noted above, data from an operational database (such as the one or more operational databases 102A), can be transformed into a desired format, e.g., for storage/use in another data repository, such as lakehouse 104. Transformation jobs 108 represent one or more operations or sets of operations intended to transform data from the one or more operational databases 102A into a format having a desired structure(s)/characteristic(s) for storage in lakehouse 104. Data transformation, as contemplated herein, can refer to one or more processes for converting, possibly cleansing, and structuring data into some useable or desired format that can be analyzed, enriching data, and so on. For example, converting data types, adding redundancy for better analytical performance (denormalizing), etc. may comprise performing ETL operations to convert data from one or more operational databases 102A into the desired format for storage in lakehouse 104. Generally, ETL refers to a process of extracting data from an input source, in this case, operational database(s) 102, transforming the extracted data (by applying rules or functions, e.g., data mapping rules, to the extracted data in preparation for loading into a target repository or service), and loading the transformed, extracted data to, in this example, lakehouse 104.

Specifically regarding the transformation, transformation jobs 108 may comprise operations or instructions to perform extraction, e.g., identifying and pulling/obtaining data from one or more operational databases 102A). Transformation jobs 108 may further comprise operations or instructions to transform data, e.g., performing: data discovery to profile data (determine structure/characteristics of the data, and how the data is to be transformed); data mapping (connecting/matching data fields from one source to another); code generation and execution (for performing actual data transformation); and data review (confirming performed transformations result in desired data format/structure). It should be noted that in some instances, e.g., when lakehouse 104 is cloud-based, the transformation process may progress in an ELT fashion, whereby source data is first loaded into lakehouse 104, and transformation is performed at lakehouse 104.

As further illustrated in FIG. 1, and in accordance with examples of the disclosed technology, a data transformation system 112 may effectuate or perform various denormalization or modeling techniques to transform data from one or more operational databases 102A prior to or upon storage of that data at lakehouse 104. In some examples, data transformation system 112 may embody ETL functionality, i.e., operating as a bridge for moving data from an operational/transactional system to an analytical system, such as a lakehouse. Data transformation system 112 can be hosted, in some examples, in the cloud, on a server, etc. Again, data from one or more operational databases 102A may be normalized, but to leverage the capabilities/advantages of lakehouse 104, data transformation system 112 may selectively denormalize or model the data.

Thereafter, as noted above, drift detection can be performed on the data that now resides in lakehouse 104 (after being extracted from operational database(s) 102A, and transforming the data). That is, the data brought from operational database(s) 102A to lakehouse 104 may not accurately represent or reflect the data/state of the data in the operational database(s) 102A. For example, the ETL processing may have caused an error(s), retries, etc. in the extracted data.

Accordingly, and as noted above, lakehouse 104 may perform operations to obtain various “sets” of the data meant to represent the data stored in operational database(s) 102A. The data loaded into lakehouse 104 may be considered to be an “initial load” that represents a snapshot of the data stored in operational database(s) 102A. A CDC mechanism may be used to capture any events that occur on the data in operational database(s) 102A. Lakehouse 104 may generate reconstructed data tables by “replaying” those events, i.e., lakehouse 104 may perform the same events on the initial load now stored in lakehouse 104. The initial load and the reconstructed tables may comprise a first set of the data, the initial load being a first version of the first set, and the reconstructed tables comprising a second version of the first set.

Additionally, lakehouse 104 may obtain snapshots of the data maintained by operational database(s) 102A to create additional sets of the data. These snapshots reflect a state of the data in operational database(s) 102A at a current time (a first version of this second set of the data), and at some determined previous time (a second version of this second set of the data). The “previous time” snapshot of the data can be/use the initial load of data from operational database(s) 104. Unlike the initial load, on which events are replayed, however, lakehouse 104 can restore each of these current and previous snapshots. That is, database snapshots can refer to read-only copies of operational database(s) 102A at some point in time, capturing the state of operational database(s) 102A's data and schema. Restoration operations may be performed to convert the snapshots (typically a read-only copy of the data) into a working version of the data, in this case the data of operational database(s) 102A, in lakehouse 104.

As will be described in greater detail below, drift and reconciliation processing system 110 may then determine any changes to the data from the reconstructed tables based on replaying the events on the initial load data at lakehouse 104. Moreover, any changes or discrepancies between the restored current and previous snapshot data can also be determined, to act as ground truth/validation mechanism for the changes determined using the reconstructed tables. These two sets of changes/change data can then be compared. If changes or discrepancies exist, i.e., data drift, drift and reconciliation processing system 110 may take corrective actions or perform corrective events to make the reconstructed tables match what is reflected in the restored current snapshot of the data of operational database(s) 102A.

FIG. 2 illustrates an example architecture of a lakehouse 200, which may be an example of lakehouse 104 (FIG. 1). As already discussed, query engine 202 may be some software or other interface configured to generate/execute queries on data. In some examples, query engine 200 may be implemented in/as part of lakehouse 200, but can often be implemented in the cloud/on a server remote or separate from either lakehouse 200 or an operational system. Lakehouse 200 may further comprise a processor 230 for effectuating data storage, and a memory 220 embodying the storage/database of lakehouse 200.

Based on the generated/executed queries by query engine 202, transformations can be effectuated. As described herein, transformations can involve various denormalization or modeling techniques that serve to leverage the advantages of a lakehouse (OTF, cheap, e.g., cloud-based object storage, columnar file formatting, etc.) while still maintaining, e.g., query performance typically achieved only with data warehouses. Through performance of these various denormalization/modeling techniques, metadata can be automatically generated, or users may specify/annotate metadata that can be used as bases for the transformations of data for storage in a lakehouse, such as lakehouse 200. Accordingly, a metadata path 205 is illustrated in FIG. 2, as is a data path 204.

Data path 204 can refer to the operations/movement of data from a source data repository, such as an operational database, to a target data repository, in this context, a lakehouse. Data path 204 and metadata path 205 can begin, in some scenarios, at the query engine since queries can be analyzed/statistics can be captured, and metadata can be generated therefrom. The same holds true of the data path 204 which can reflect the movement of data (from operational database to lakehouse) and its transformation from a source format/structure to that suited for a lakehouse, as well as in accordance with suggested denormalization/modeling or based on the query analysis. A catalog 206, such as a metastore, can be used to store and provide information regarding directory structure, file format, and metadata about stored data. Object storage access can be mediated through catalog 206. A user 110 (FIG. 1) may specify metadata recipes for transformation jobs, and catalog 206 can be used to store a dictionary/glossary of data mapping rules, for example.

Connector 207 can refer to services/functions that connect source data to a lakehouse, in this example the object storage 210 of lakehouse 200. Connector 207 can be used to, e.g., obtain a snapshot of source data, and the monitor and record changes to that data, e.g., a CDC connector. Depending on the desired output format, different connectors may be used, e.g., a particular open table format 208. As noted above, and as will be described in greater detail below, the CDC capture of events allows lakehouse 200 to reconstruct the tables of an operational system/database(s). That is, the CDC capture provides information regarding the events that occurred on the data of the operational database(s), so that the events can be replayed on the data so that the data (e.g., the initial load) can be exposed to/experience the same operations as that experienced in the operational database(s).

Object storage 210 refers to the data storage architecture typically used in lakehouses. Object storage, an example of which is Amazon S3, is geared to storing unstructured data. That is, data can be sectioned into units, also referred to as objects. The objects may then be stored in a structurally flat data format or environment. In this context, flat (flat file) can refer to a collection of data stored in a 2D database in which similar but distinct strings of information are stored as records in a table. The columns of a table can be representative of one dimension of the database, while each row is representative of a separate record

Columnar storage 209 refers to the manner in which data can be structured in the object storage 210 of lakehouse 200. In particular, when using or applying columnar storage, each data block stores or represents values of a single column for multiple rows, e.g., a column may contain the values of a specific attribute across all records. Different columnar storage formats exist, e.g., Parquet (generally known to be optimized for ready-heavy workloads and compatible with analytical tools like Apache Spark), and ORC, which tends to be more suited to write-heavy workloads and supports ACID transactions.

Open table format 208 can refer to “wrappers” that provide a layer of abstraction atop object storage 210 of lakehouse 200, allowing data to be managed/optimized in an efficient manner. In particular open table format 208 may comprise a set of files that can track schema/partition changes in a database/table, a table's data files and column statistics, as well as any inserts, updates, or deletes on a table. Examples of open table formats include Apache Iceberg, Delta Lake, and Apache Hudi.

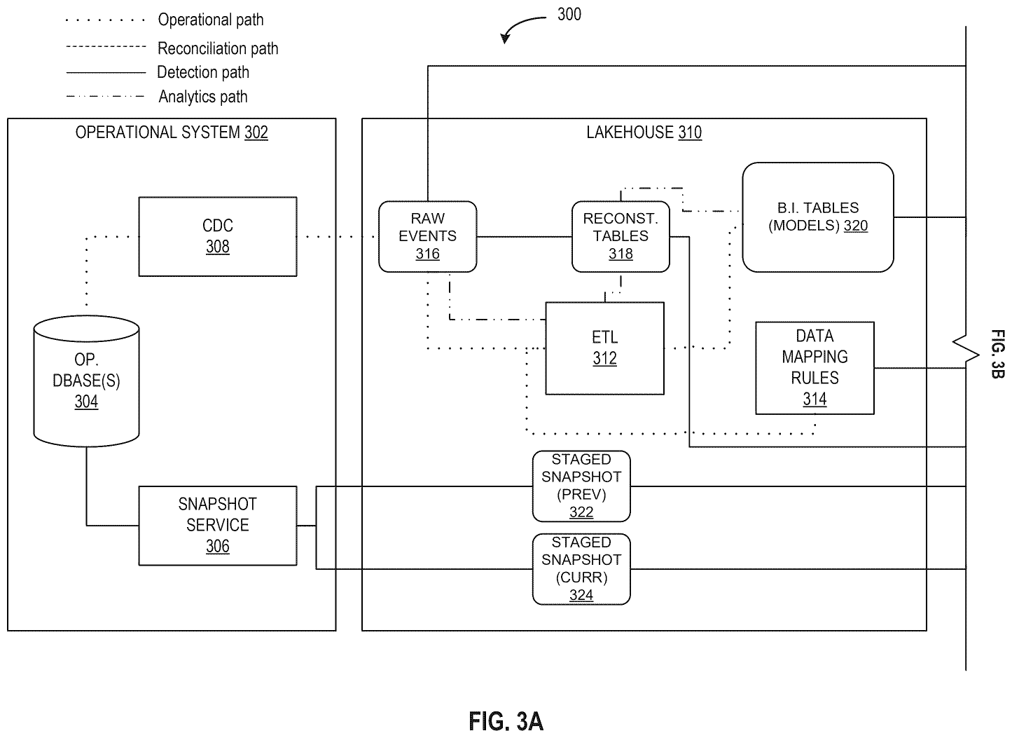

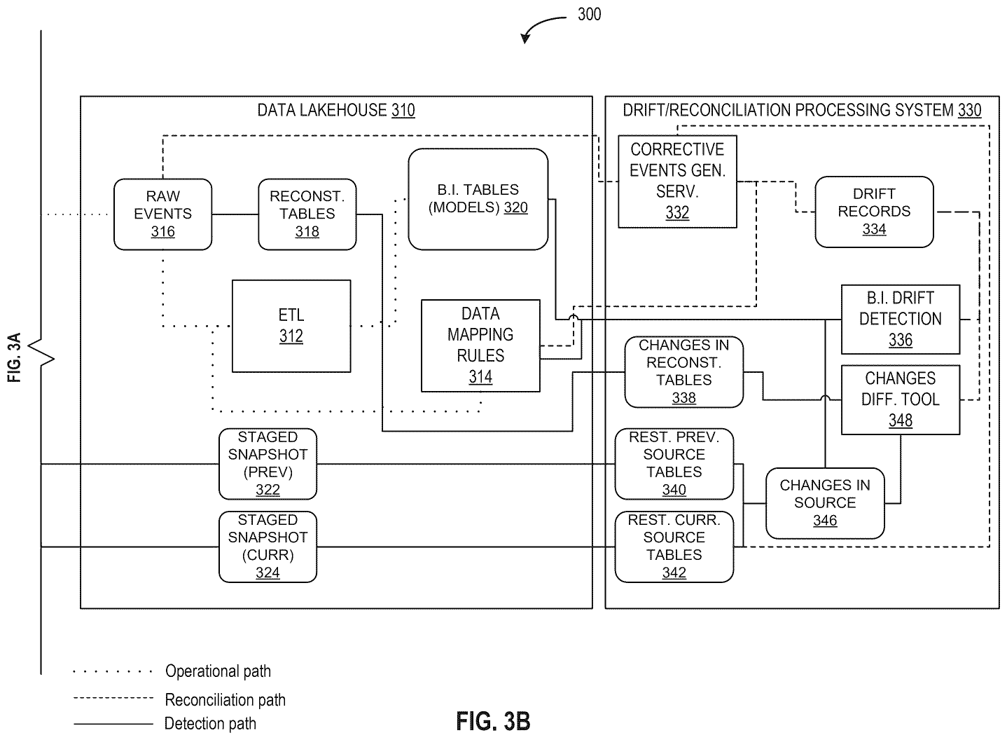

FIGS. 3A and 3B are more detailed schematic representations of a drift detection and reconciliation architecture and process in accordance with some examples of the disclosed technology. In the interests of clarity and ease of illustration, interactions between operational system 302 and lakehouse 310 are illustrated in FIG. 3A, while interactions between lakehouse 310 and drift/reconciliation processing system 330 are reflected in FIG. 3B. Operational system 302 may be an example of operational system 102 of FIG. 1, lakehouse 310 may be an example of lakehouse 104, and drift/reconciliation processing system 330 may be an example of drift/reconciliation processing system 110.

As illustrated in FIG. 3A, operational system 302 may comprise one or more operational databases 304. Operational database(s) 304 may typically comprise a relational database (e.g. MSSQL server, MySQL, Postgres etc.) serving operational mission-critical workloads characterized by high volume of selective writes and ACID guarantees. Operational systems, such as operational system 302, often maintain the latest state of the system, but not necessarily an entire history of its operational database(s), e.g., operational database(s) 304.

A snapshot service 306 comprises a service for determining a given state of the operational/transactional database. Most operational systems, such as operational system 302, follow a regular snapshot and backup schedule. Different database systems include their own respective snapshot services or functionalities, e.g., Amazon RDS allows users to create snapshots of database instances stored in S3, Microsoft SQL server allows for data-page level snapshots, where sparse files are used to store copied pages, and the Debezium platform includes the ability to generate initial snapshots, incremental snapthots, etc.

In order to replicate the changes to a backend (e.g., a data warehouse or lakehouse, where the operational database(s) may be considered to be the frontend) in the least interfering manner, a connector, such as a Debezium connector can be deployed to monitor any changes happening to the operational system. Such changes can be communicated to the backend.

As discussed above, a lakehouse, such as lakehouse 310, may comprise a connector (e.g., connector 207 of FIG. 2) for connecting to services/features of operational system 302, in particular, the aforementioned snapshot service 316 to, e.g., obtain a snapshot of source data, and then to monitor and record changes to that data via a CDC module 308. For example, it should be understood that CDC functionality is present in both operational system 302 and lakehouse 310, with the connector acting as a bridge between operational system 302 and lakehouse 310, i.e., listening to or for changes in operational system 302 via CDC module 308.

For the initial load of data, a database snapshot is taken, and change data can subsequently be captured. For example, the connector (shown in FIG. 2) of lakehouse 310 may connect to operational database(s) 304, and may obtain a snapshot of operational database(s) 304 from snapshot service 306. As discussed above, operational system 302 may periodically take snapshots, e.g., on a daily or weekly (or other) basis.

In recent years, with the advent of open source query engines, data catalogs, open table formats-users/entities have seen the benefits of combining their AI and BI data sources in a central lakehouse that offers cost efficiency and flexibility of data lakes, with query performance and knowledge representation of data warehouses. Again, a database snapshot may comprise a read-only, static view of a source database, and is transactionally consistent with that source database at the time of the snapshot's creation. For example, the first time that lakehouse 310's connector connects to operational database(s) 304, a consistent snapshot can be taken. Thereafter, the connector may continuously capture any changes committed to operational database(s) 304, e.g., row-level changes, that result in the insertion, deletion, or updating of the data stored in operational database(s) 304. In the case of a Debezium connector, the connector can generate data change event records, which can then be streamed as Kafka topics. Lakehouse 310 can then listen to operational database(s) 304, and consume that information as raw events 316 that can be dumped to lakehouse 310 from operational system 302. In some examples, CDC module 308 may comprise a CDC connector output plugin that can be installed in operational system 302. Due to relatively cheap object storage and efficiency of the columnar format, the aforementioned raw events 316 are persisted in lakehouse 310 (traditional warehouses tend to have transient staging of raw events).

Transactional tables (typically dimension tables from Kimball modeling, that are representative of operational database(s) 304) are reconstructed at lakehouse 310. This is done using an appropriate MERGE statement to apply changes to tables comprising the initial load/first snapshot of operational database(s) 304. It should be understood that an SQL MERGE statement is a clause that can be used to handle inserts, updates, and deletes in a singular transaction. Typically, a MERGE statement attempts to compare a source database table to a target database table based on, e.g., some key field, and performing the MERGE processing. In accordance with examples of the disclosed technology, MERGE processing can consider the raw events 316 information gleaned from the output of CDC module 308, i.e., a representation of the source database (operational database(s) 304), to generate reconstructed tables 318 in lakehouse 310 based on the initial load/first snapshot of operational database(s) 304, i.e., the target database tables. At this point, examples of the disclosed technology have a first representation of operational database(s) 304 generated by reconstructing tables via merging raw events with an initial load, i.e., replaying events on the data from operational database(s) 304. In this way (obtaining an initial full load for tables of operational database(s) 304, staging raw events, and applying MERGE rules), one representation of ground truth can be reconstructed. It should be understood that the term “reconstructed” is used because the tables of lakehouse 310 are reconstructed by the replaying of raw events on the initial load to arrive at a desired state of the data. This is in contrast to restored tables based on the restoration of snapshots from operational database(s) 304, described in greater detail below.

ETL module 312 comprises ETL processes that can be performed by lakehouse 310 in order to parse raw events to create BI tables 320. A dictionary/glossary of data mapping rules 314 (lineage/provenance) is maintained for data governance purposes. BI tables 320 can be developed based on raw events through the ETL process by applying data mapping rules to incoming CDC information (raw events). That is, the data mapping rules comprise the metadata/transformations needed to construct BI tables from a transactional/operational data model via ETL. Again, ETL stands for extract (data from the transactional/operational system), transform (the data by applying data mapping rules), and load (the transformed data into a warehouse, or in this instance, a lakehouse). In turn, the BI tables 320 and data mapping rules 314 can be used to generate corrective events via a corrective events generation service 332 (see, FIG. 3B). That is, once drift is determined in accordance with the disclosed technology, corrective events can be determined, used to supplement raw events data 316, and applied (via MERGE statements) to the reconstructed tables of lakehouse 310 to bring them in line with ground truth for operational database(s) 304.

A second representation of the data maintained by operational database(s) 304 may comprise a current snapshot of operational database(s) 304 that can be staged in lakehouse 310 (current staged snapshot 324), after copying the snapshot file(s) from operational database(s) 304 or operational system 302. The initial load of operational database(s) 304 to lakehouse 310, as noted above, may be a snapshot of operational database(s) 304. In this case, the initial load may be considered to be a previous snapshot of operational database(s) 304, recalling that operational system 302 may configure snapshots to be taken by snapshot service 306 in accordance with some schedule, which is typically periodic, but could be aperiodic as well. Like the current snapshot, the previous snapshot can also be staged in lakehouse 310 (previous staged snapshot 322). As will be described in conjunction with FIG. 3B, these staged current and previous snapshots 324/322 may be restored as working instances in lakehouse 310, i.e., restored previous source tables 340 and restored current source tables 342 (FIG. 3B).

Referring now to FIG. 3B, The difference(s) between the data comprising the previous and current snapshots represented by the restored previous and current source tables 340/342 can be determined by comparing the two restored source tables. Changes in the reconstructed tables can also be determined, e.g., by comparing the initial load data, and the data reflected in the reconstructed tables 318 (shown in FIG. 3A). That is, the detection path can include current and previous restored snapshots and changes in source, as well as changes in destination (the reconstructed tables 318 in lakehouse 310). The previous restored snapshot can refer to the restored database snapshot (restored previous source tables 340) for, e.g., a previous week if snapshots are obtained on a weekly basis. This would be already existing in a destination database instance, i.e., lakehouse 310, when the snapshot and drift detection/reconciliation process completed that previous week. The changes in source 346 are the exact changes that happened in the source (operational database(s) 304) during the last week.

Depending on the database, optimal tools (e.g., pg_comparator for Postgres) already exist to identify creates, deletes, and updates to the source tables. It should be noted that both the previous and current snapshots are restored to the same “database schema” making the process of identifying the delta or difference therebetween even more efficient. There are also other tools like data_diff, which can be leveraged to calculate this difference efficiently.

Also included in the detection path are a changes difference/diff tool 348 and a BI drift detection tool 336. Regarding changes in destination, i.e., lakehouse 310, open table formats maintain a detailed transaction log, and therefore, the exact changes (create, inserts, deletes) applied to tables in the lakehouse between two timestamps can be obtained. The changes diff tool 348 performs a “diff of diffs” operation between the changes in source and changes in destination for any reconstructed/dimension tables to determine the delta between the changes in source and changes in destination—this is the data drift. The BI drift detection tool 336 may be similar to the changes diff tool, but since BI tables have a different schema from source tables, this tool applies data mapping rules to the changes in source (changes that happened to source tables) to come up with desired changes to BI tables. The BI drift detection tool 336 then compares desired changes to the changes in destination (the actual changes applied to BI tables) and identifies the delta.

The reconciliation path may traverse a corrective events generation service 332, which receives data mapping rules 314, determined drift records 334, and the restored current source tables 342, as well as the detected drift information from BI drift detection tool 336, and changes diff tool 348. Because the exact drift is identified for reconstructed tables 318 (shown in FIG. 3A) and BI tables 320 using the changes diff tool 348 and the BI drift detection tool 336, “correcting” events to apply to the lakehouse tables are known. This corrective events generation service 332 operates on the “diff of diffs” to create the events in a desired format to apply them to the reconciliation path. A metadata field in the event can be modified to keep track of “corrective” events for cataloging purposes. This “surgical” operation to “manufacture” the events for reconciliation makes it possible to leverage the operational path for the reconciliation process instead of creating a separate reconciliation pipeline. The operational path may include a data path from operational database(s) 304 to CDC module 308 (where changes to the operational database(s) 304 are listened to), and on to raw events 316 which can be used, via MERGE operations, to generate reconstructed tables 318. The operational path may further include the path between raw events data 316 and ETL module 312, between ETL module 312 to BI tables 320/data mapping rules module 314.

It should be noted that generated events are applied to the raw stage as opposed to directly correcting final BI views. This can be a preferable approach since doing so ensures that all stages of processing are in sync, and that end-to-end cataloging of changes that occurred exists, and that replay-ability if so needed, is also possible. To achieve this, drift and reconciliation processing system 330 may obtain data mapping rules from data mapping rules module 314, and may obtain extra data from the latest restored snapshot (restored current source tables 342) to generate all corrective events depending on the complexity of data transformation in the lakehouse 310. To elaborate, there are three modes in which reconciliation can be performed. In a regular mode, drift and reconciliation processing system 330 may have all the context from the upstream changes diff tool 348, and is aware of exact changes to be applied to exact tables based on detected drift. This is typically the case with reconstructed tables or dimensions tables. In denormalization mode, the data-mapping/transformation logic found in data mapping rules tool 314 and data transformation system 112 (FIG. 1) involves joining multiple tables whereas the drift may have been detected for only some of the tables. Rather than relying on ETL jobs to fetch appropriate data to create a corrective row for a final view, this mode fetches rows from relevant tables from the latest/current snapshot, and creates events for all involved tables. For example, if users and customers tables were being joined as part of customer_users view in a BI table, drift detection may detect a particular user attribute wasn't updated in customer_users. However, constructing a corrected row for the customer_users table requires joining rows from both source tables. So, corrective events generation service 332 ensures it reaches out to the latest restored snapshot (restored current source tables 342) to get the relevant row from both tables, and generates needed events for both the customers and users tables which translates to the desired change for customer_users through regular processing. It should be noted that obtaining records from both source tables is not necessarily required, however. In some examples, a MERGE statement can be applied to raw events data, allowing only a subset of columns to be updated.

With respect to an aggregation mode, ETL transformations may involve hourly/daily/weekly aggregations as part of the BI pipeline. As part of drift detection, data mapping rules from data mapping rules module 314 can be applied to the changes in source 346, and detect that the aggregation value is incorrect. However, as previously indicated, the BI view is not “directly” corrected, but rather it is ensured that corresponding corrective events are generated in raw form. For this case, corrective events generation service 332 reaches out to the latest/current snapshot to get all records within the relevant aggregation window so that corresponding calculations are performed again.

Consider, for example, a scenario where user onboardings are being accumulated (added) every day to create a daily_onboarded_users view from a users source table in the operational system. The BI drift detection tool 336 can apply the data transformation (data mapping rules) on the delta between restored previous and current snapshots on the users table. Corrective events generation service 332 finds the actual number of total onboarded users for a previous day, and determines they do not match those in the daily_onboarded_users view obtained from a change data feed on the BI view (the portion of the detection path between BI tables 320 and BI drift detection tool 336. In this case, since the data mapping rule and aggregation window are known to corrective events generation service 332, corrective events generation service 332 can access the latest restored snapshot endpoint to retrieve all rows for the previous day, and creates all those as corrective events for raw data. Moreover, a regular transformation pipeline re-does aggregation for the previous day's window based on the generated events.

It should be noted that the frequency of detecting data drift depends on multiple factors, including, but not necessarily limited to: cost; snapshot schedule; domain knowledge; and business requirements. It may also be beneficial to be adaptive while deciding a schedule for drift detection. This approach allows for a configurable cadence for drift detection.

To ensure reconciliation is complete and data can be relied upon, the following may be performed: monitoring an events generation service for completion; obtaining a change feed in destination during a reconciliation window; comparing the previous restored snapshot with an originally-recorded drift. It should be noted that there may be other changes in the destination during the time from the regular operational path. Those may be ignored, as the criterion is to make sure all recorded drift is corrected. Reconciliation can be considered complete if all drift is reconciled, e.g., all drifted records have a corresponding change at destination during a reconciliation window. If some gaps are found, new drift records are noted, and the process may be repeated.

It should be further noted that some limitations may exist, depending on the context available from the source system and the cadence of snapshots. For example, if every user login action updates the latest_login field from the source user table, although all the incremental changes are available in the CDC, they cannot be detected as changes in snapshots restored for last week and the current week. This is because users may have logged in and out multiple times during the week. However, this can be addressed so long as an independent ground truth exists for changes happening to the database (e.g. a candidate could be the kafka queue configured for the debezium connector which retains CDC for some time).

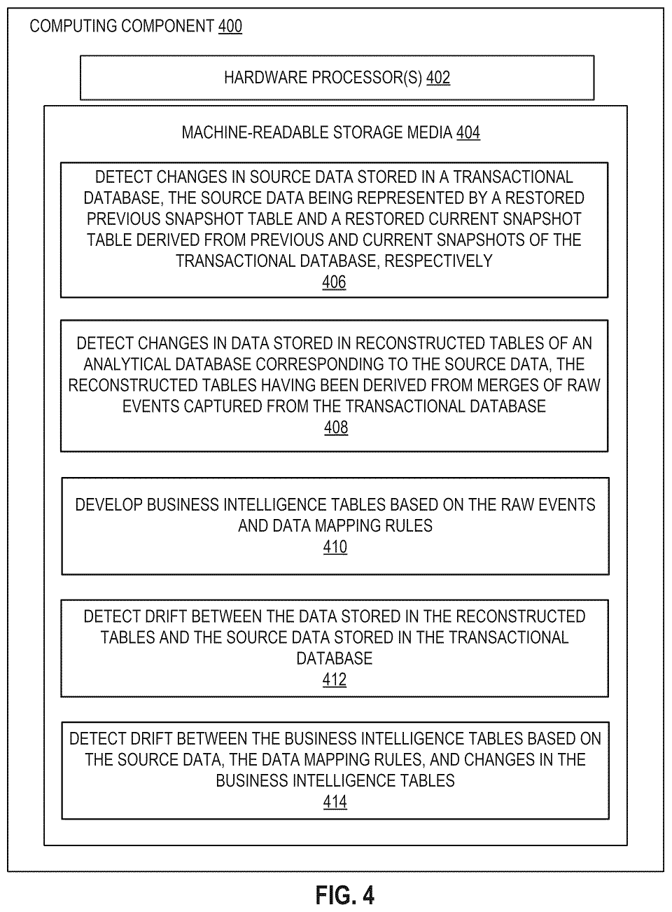

FIG. 4 illustrates an example computing component that may be used to perform metadata-driven data transformation in accordance with various embodiments. Computing component 400 may be, for example, a server computer, a controller, or any other similar computing component capable of processing data. In the example, computing component 400 includes hardware processor 402, and machine-readable storage medium 404.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-410, to control processes or operations for performing automated drift detection and reconciliation in accordance with an example of the disclosed technology. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-410.

In some examples, hardware processor 402 may execute instruction 406 to detect changes in source data stored in a transactional (operational) database, the source data being represented by a restored previous snapshot table and a restored current snapshot table derived from previous and current snapshots of the transactional database, respectively. As discussed above, ground truth regarding changes in data can be established by taking such previous/current snapshots of the data in the transactional/operational database using a snapshot service that may be run in an operational system in which the transactional/operational database is maintained or resides. In the lakehouse, those previous/current snapshots (which are static read-only files) can be staged and used to restore previous source and current source tables reflecting a previous and current state of the data in the transactional/operational database. Using these restored source tables, changes in the data can be determined.

In some examples, hardware processor 402 may execute instruction 408 to detect changes in data stored in reconstructed tables of an analytical database corresponding to the source data, the reconstructed tables having been derived from merges of raw events captured from the transactional database. As described herein, examples of the disclosed technology reconstruct tables corresponding to the transactional/operational database. The aforementioned previous snapshot of the transactional/operational database can also serve as an initial data load in the analytical database, which can be a lakehouse. A CDC connector in the lakehouse can be used to obtain or collect raw events that occurred or were performed on the data in the transactional/operational database. Using MERGE statements or techniques, the raw events data can be applied to the initial load/previous snapshot to generate reconstructed tables that are also meant to represent or reflect a current state of the operational/transactional database. In this way, any changes in data between the initial load and the reconstructed tables can be determined, e.g., a first set of change information or data. Likewise, changes in data between the restored previous and current snapshot tables can also be determined, e.g., a second set of change information or data.

In some examples, hardware processor 402 may execute instruction 410 to develop BI tables based on the raw events and data mapping rules. As noted above, analytical data/BI tables can be developed based on raw events and the application of data mapping rules to incoming CDC information.

To the above, in some examples, hardware processor 402 may execute instruction 412 to detect drift between the data stored in the reconstructed tables and the source data stored in the transactional database. That is, the two sets of change information or data can be compared, with the second set of change information or data acting as ground truth regarding changes in the source (by performing a diff of diffs comparison or operation) to determine if data drift has occurred between the source (transactional/operational database) and the destination (lakehouse).

In some examples, hardware processor 402 may execute instruction 414 to detect drift between the BI tables. As also noted above, a BI drift detection tool, similar to the changes diff tool can apply data mapping rules to the changes in the source data (changes that occurred regarding source tables, and changes in the BI tables) to determine the drift.

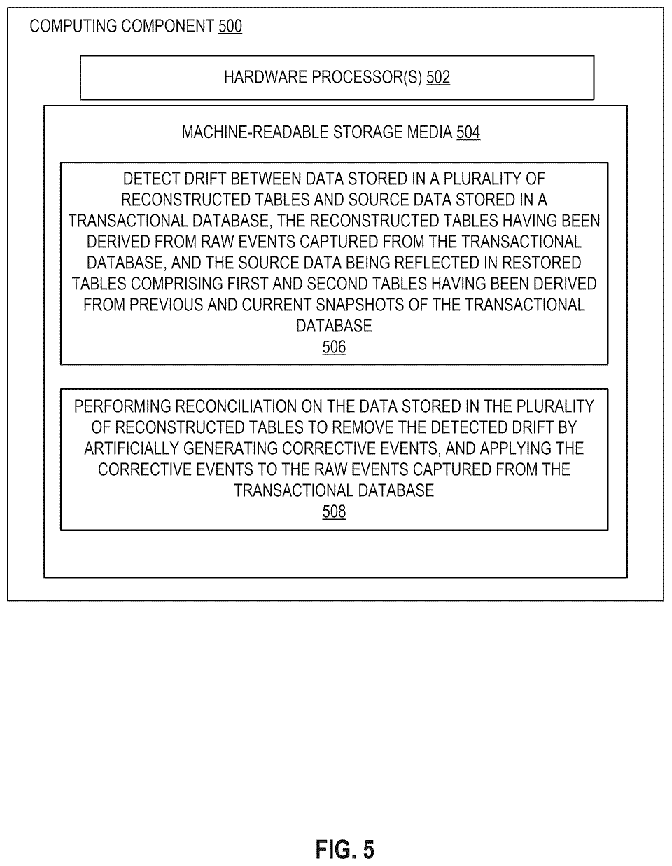

FIG. 5 illustrates an example computing component that may be used to perform metadata-driven data transformation in accordance with various embodiments. Computing component 500 may be, for example, a server computer, a controller, or any other similar computing component capable of processing data. In the example, computing component 500 includes hardware processor 502, and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-508, to control processes or operations for performing automated drift detection and reconciliation in accordance with an example of the disclosed technology. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-508.

In some examples, hardware processor 502 may execute instruction 506 to detect drift between data stored in a plurality of reconstructed tables and source data stored in a transactional database, the reconstructed tables having been derived from raw events captured from the transactional database, and the restored tables comprising first and second tables having been derived from previous and current snapshots of the transactional database. As described above, examples of the disclosed technology generate various versions or sets of data meant to represent the state of data in the transactional database. The previous/current snapshots of the transactional database can serve as ground truth, any differences between the snapshots reflecting changes to the data in the source/transactional database. In parallel, a lakehouse or analytical database to which data is ported from the transactional database (to facilitate analytical/AI-oriented insights) can reconstruct the tables of the transactional database using raw events information gleaned from CDC processing that can be applied to an initial load of the data from the transactional database. It should be understood that operational systems, such as that in which the transactional database resides, typically capture snapshots of its data periodically, e.g., every day or every week, etc. The initial load can be a previous snapshot of the data in the transactional database. Upon reconstructing the tables, changes between the initial load of the data and the reconstructed tables (which theoretically capture events that reflect actions (inserts, deletes, changes, etc.) performed on the data) can be determined. In this way, there is a set of data reflecting changes in the source data gleaned from snapshots of the transactional database, and a set of data reflecting changes in the destination data gleaned from the reconstructed tables. Any differences between these two sets of data reflect any data drift that has occurred between the transactional database and the lakehouse.

In some examples, hardware processor 502 may execute instruction 508 to perform reconciliation on the data stored in the plurality of reconstructed tables to remove the detected drift by artificially generating corrective events, and applying the corrective events to the raw events captured from the transactional database. That is, the raw events that were leveraged to reconstruct the tables of the transactional database that were ported to the lakehouse in an initial load, via ETL operations that can be performed to parse the raw event data to create BI tables by applying data mapping rules to CDC information. In turn, the BI tables 320 and data mapping rules 314 can be used to generate corrective events via a corrective events generation service. These corrective events can be used to augment the raw events data, and can be applied to the reconstructed tables in the lakehouse to “synchronize” the source (transactional database) and destination (lakehouse).

The examples of the disclosed technology provide methods to precisely detect drift as opposed to merely, a general identification of drift, or merely giving a confidence score to data in a data warehouse or lakehouse. Additionally, exact events to generate can be identified, as opposed to performing a full load or replaying all events after a certain timestamp for reconciliation, which can involve the transfer of large amounts of redundant data. Further still, automated and standardized drift detection/reconciliation is realized. Examples of the disclosed technology result in a system that can be generic and non-specific to a particular shape or domain of data. This makes it very easy to apply to newer analytical pipelines and databases. That is, existing script approaches are too customized, and do not scale well.

Data mapping rules can be used to identify drift in BI tables and a restored snapshot can be used to retrieve exact records to generate events for reconciliation of BI tables. As described above, data mapping rules are a type of metadata, which is the norm for data governance purposes, and that metadata can be leveraged, thereby achieving metadata aware drift detection and reconciliation.

Operational systems need not be overloaded. Again, there is no need for performing a full load or replay of events in the past from a source operational system, thus avoiding any impact on production services. Examples of the disclosed technology are also well-suited to lakehouses. Indeed, many features of lakehouses (columnar formats, change data feed, etc.) can be leveraged. Moreover, exact and efficient comparisons of restored snapshots as homogeneous co-located sources results in optimal performance. Additionally still, no downtime is required since drift and reconciliation process seamlessly integrates with and leverages the operational path. Lastly, since examples of the disclosed technology can precisely identify drift, costs associated with compute/storage/network processing associated with doing a full load or replaying past events are avoided.

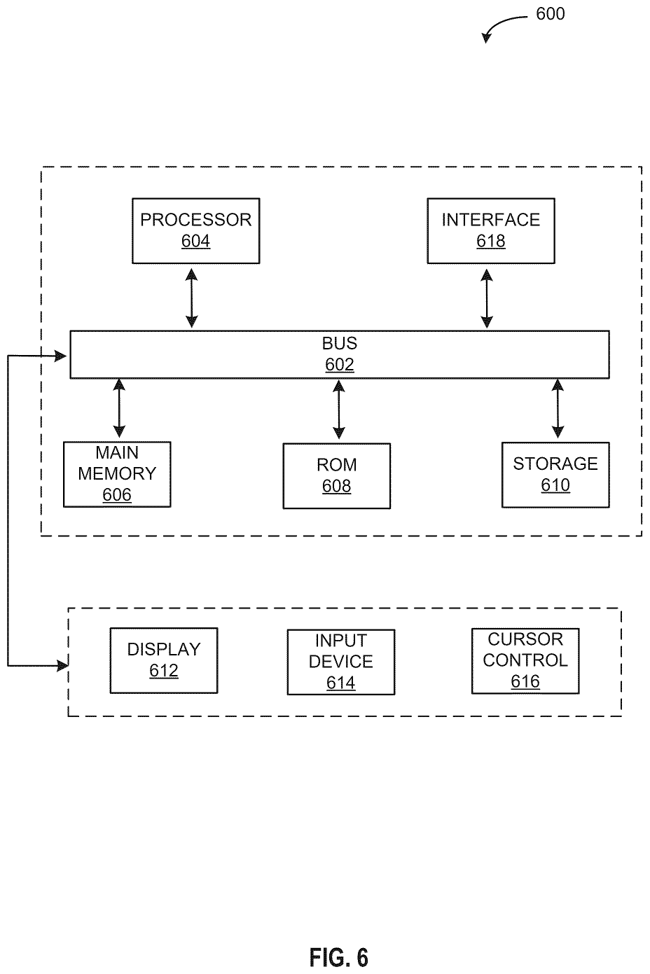

FIG. 6 depicts a block diagram of an example computer system 600 in which various examples described herein may be implemented. Computer system 600 includes bus 602 or other communication mechanism for communicating information, one or more hardware processors 604 coupled with bus 602 for processing information. Computer system 600 may be computer system embodying or executing instructions to effectuate the functionality of data transformation system 112, operational system 100, query engine 106, lakehouse 104, drift and reconciliation processing system 110, etc.

Computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes read only memory (ROM) 606 or other static storage device coupled to bus 602 for storing static information and instructions for processor 604. Storage device 610, such as a magnetic disk, optical disk, or USB thumb drive (Flash drive), etc., is provided and coupled to bus 602 for storing information and instructions.

Computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

Computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Non-transitory media is distinct from but may be used in conjunction with transmission media.

Computer system 600 also includes interface 618 coupled to bus 602. Interface 618 provides a two-way data communication coupling to one or more network links that are connected to one or more local networks.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
detecting changes in source data stored in a transactional database, the source data being represented by a restored previous snapshot table and a restored current snapshot table derived from previous and current snapshots of the transactional database, respectively;
detecting changes in data stored in reconstructed tables of an analytical database corresponding to the source data, the reconstructed tables having been derived from merges of raw events captured from the transactional database;
developing business intelligence (BI) tables based on the raw events and data mapping rules;
detecting drift between the data stored in the reconstructed tables and the source data stored in the transactional database; and
detecting drift between the BI tables based on the source data, the data mapping rules, and changes in the BI tables.

2. The method of claim 1, wherein the method further comprising restoring the previous and current snapshots to the same database schema.

3. The method of claim 1, wherein the merges of the raw events comprises reconstructions of tables comprising an initial data load from the transactional database to the analytical database in accordance with changes to the data reflected in the raw events.

4. The method of claim 1, wherein the instructions that when executed cause the processor to detect changes in data stored in the reconstructed tables, comprise further instructions that when executed cause the processor to obtain the raw events via a continuous data capture (CDC) connector in the analytical database.

5. The method of claim 4, wherein the CDC connector is operatively connected to a CDC module capturing the raw events that occurred on the data stored in the transactional database.

6. The method of claim 5, wherein the instructions that when executed, cause the processor to develop BI tables based on the raw events and data mapping rules comprise further instructions that when executed, cause the processor to apply the data mapping rules to the raw events in the analytical database.

7. The method of claim 6, wherein the data mapping rules comprise at least one of metadata and data transformations that are maintained for data governance in the analytical database

8. The method of claim 6, wherein the application of the data mapping rules to the raw events results in the development of the BI tables from a transactional data model via an extract, transform, and load operation.

9. The method of claim 8, wherein the memory comprises further instructions that when executed, cause the processor to generate corrective events using the BI tables and the data mapping rules.

10. The method of claim 8, wherein the memory comprises further instructions that when executed, cause the processor to detect an incorrect aggregation value when the extract, transform, and load operation involves periodic aggregation.

11. The method of claim 10, wherein the memory comprises further instructions that when executed, cause the processor to obtain all data records from the current snapshot within a relevant aggregation window to re-perform the periodic aggregation.

12. The method of claim 9, wherein the memory comprises further instructions that when executed, cause the processor to generate the corrective events using additional data from the restored current snapshot table.

13. The method of claim 9, wherein the memory comprises further instructions that when executed, cause the processor to apply the raw events and the corrective events to the reconstructed tables and the BI tables of the analytical database to match the current snapshot of the transactional database thereby reconciling the detected drift.

14. The method of claim 1, wherein the memory comprises further instructions that when executed, cause the processor to, when the drift is detected in only a subset of the reconstructed tables, fetch rows of tables from the current snapshot corresponding to the subset of the reconstructed tables to generate corrective events.

15. A method, comprising:
detecting drift between data stored in a plurality of reconstructed tables and source data stored in a transactional database, the reconstructed tables having been derived from raw events captured from the transactional database, and the source data being reflected in restored tables comprising first and second tables having been derived from previous and current snapshots of the transactional database; and
performing reconciliation on the data stored in the plurality of reconstructed tables to remove the detected drift by artificially generating corrective events, and applying the corrective events to the raw events captured from the transactional database.

16. The method of claim 15, further comprising restoring the previous and current snapshots to the same database schema to generate the restored tables.

17. The method of claim 15, further comprising applying data mapping rules to the raw events to construct business intelligence (BI) tables, detect drift in the BI tables using the source data, the data mapping rules, and changes in the BI tables, and performing reconciliation on the data stored in the BI tables to remove the detected drift by further applying the data mapping rules to the corrective events.

18. The method of claim 17, further comprising using the analytical data model in conjunction with the data mapping rules to artificially generate the corrective events.

19. A system, comprising:
a processor; and
memory comprising instructions that when executed, cause the processor to:
detect changes in source data stored in a transactional database, the source data being represented by a restored previous snapshot table and a restored current snapshot table generated based on previous and current snapshots of the transactional database, respectively;
detect changes in data stored in reconstructed tables of an analytical database and in data stored in business intelligence (BI) tables, the data stored in the reconstructed tables being generated from an initial data load from the transactional database to which captured raw events from the transactional database have been applied, the data stored in the BI tables being generated by applying data mapping rules to the raw events;
detect drift between the data stored in the reconstructed tables and the source data stored in the transactional database by comparing the detected changes in data stored in the reconstructed database and the detected changes in the source data in the transactional database; and
detect drift in the data stored in the BI tables based on the source data, the data mapping rules, and changes in the BI tables.

20. The system of claim 19, wherein memory comprises further instructions that when executed cause the processor to apply the raw events and generated corrective events to the reconstructed tables and the BI tables of the analytical database to match the current snapshot of the transactional database thereby reconciling the detected drifts.
